(19) United States
(12) Patent Application Publication
(10) Pub. No.: US 2019/0050784 A1
(43) Pub. Date: Feb. 14, 2019

(54) SYSTEMS AND METHODS FOR DYNAMIC METRICS MAPPING

(71) Applicant: Walmart Apollo, LLC, Bentonville, AR (US)

(72) Inventors: Andrew B. Millhouse, Gilbert, AZ (US); Jacob R. Schrader, Sterling, IL (US); Jeffrey Alan Ward, Casa Grande, AZ (US)

(21) Appl. No.: 16/059,385

(22) Filed: Aug. 9, 2018

Related U.S. Application Data
(60) Provisional application No. 62/543,210, filed on Aug. 9, 2017.

(51) Int. Cl. G06Q 10/06; H04W 4/029; H04W 4/33; G06F 9/451

(52) U.S. Cl. CPC G06Q 10/063114; G06Q 10/06312; G06Q 10/083; H04W 4/33; G06F 9/451; H04W 4/029

(57) ABSTRACT

Systems and methods for automatic population of user interface elements on one or more client interfaces are disclosed. A user's previous configuration can be retrieved from a local or remote server configuration data store including a plurality of configuration definitions. Configuration definitions can include one or more user interface elements that have one or more requirements for data. A data aggregator can be configured to retrieve the data required by each of the one or more user interface elements of the selected configuration definition from one or more databases. A display generator can store a plurality of renderable structures defining a display, incorporating the received data of the one or more user interface elements of the selected configuration definition of the client interface. In embodiments, each of the one or more client interfaces can be further configured to receive data inputs from the identified user of the client interface.

### RELATED APPLICATION

The present application claims the benefit of U.S. Provisional Application No. 62/543,210 filed Aug. 9, 2017, which is hereby incorporated herein in its entirety by reference.

### TECHNICAL FIELD

Embodiments of the present disclosure relate generally to the field of supply chain management.

### BACKGROUND

Supply chain management involves the monitoring and control of the flow of goods and services. In complex retail environments, supply chain management can involve communication with suppliers, shipping companies, warehouses, retail stores, and other entities to coordinate receiving and dispatch of goods. Logistics managers therefore often need to monitor multiple aspects of a supply chain at once.

Data and computer control are important aspects of modern supply chain management. Various components of supply chain systems often include an interface to view data, or perform actions such as updating data or sending messages and requests. The disparate systems needed to perform these tasks are often provided by a number of different vendors or are developed in-house on an as needed basis.

As a result, logistics managers often need to have multiple screens, applications, and/or queries within applications open at the same time in order to monitor the various aspects that are of interest at any given time. This can require dozens of windows for effective management. In addition, some applications require logistics managers to repeatedly query (or “refresh”) information from multiple sources due to the lack of live or automatically queried data. This requires managers to not only need to know where but when and what to query to find action items. The lack of integration can also create data processing inefficiencies if multiple users are querying for the same (or similar information).

A need exists therefore for systems and methods to provide users with integrated views and access to a variety of supply chain system components.

### SUMMARY

Embodiments of the present disclosure provide a system for automatic population of user interface elements, including map elements on one or more client interfaces, based on a configuration specific to an identified user of each of the one or more client interfaces. The system can comprise a user history server, one or more facility configuration servers, a data aggregator, and a display generator.

In embodiments, the system can automatically augment a map based on resource attributes of one or more fixed or movable resources. The system can comprise one or more resource data providers that are configured to store a plurality of resource attributes including a location attribute and an identifier attribute for each of the one or more resources, provide the identifier attributes for the resources having a location attribute within a given area, and provide the plurality of resource attributes for an identified resource based on the identifier attribute of the identified resource.

In embodiments, a map generator can be configured to retrieve location attributes from a location master table and to store a plurality of renderable structures defining a display of one or more active maps, based on a map definition and a current area of each of the one or more active maps. A location query generation engine can be configured to receive the map definition of each of the one or more active maps, generate one or more requests for the identifier attributes of the resources located within the current area of each of the one or more active maps, and generate a request for at least one of the plurality of resource attributes of each identified resource. A positioning system can be configured to deliver each of the one or more requests to the one or more resource data providers and to store the provided attributes in the location master table.

In embodiments, at least one of the resource attributes is a resource type attribute and each resource can have a fixed resource type and a movable resource type. The resource data providers can comprise a fixed location data store configured to provide an identifier attribute for each of the one or more resources having a fixed resource type and a location attribute within an area, a movable resource locator configured to provide a location attribute for each of the one or more resources having a movable resource type, and an attribute data store configured to provide the plurality of resource attributes for an identified resource.

In embodiments, the movable resource locator can comprise one or more work management systems each arranged at a known location and configured to receive a task indication related to a resource, and communicate information associated with the task indication to a location log database configured to store a location record associated with the task indication including the known location of the work management system, the identifier attribute of the related resource, and a timestamp.

In embodiments, a current location database can be configured to request the location record with the most recent timestamp for one or more identified resources. A beaconing engine can be configured to provide a location attribute for each of the one or more resources having a movable resource type by requesting the most recent location records for the resources having a movable resource type from the current location database, determining the location attribute for each of the one or more resources based on the most recent location record if the timestamp of the location record is within threshold period, and determining the location attribute for each of the one or more resources based on a location of one or more beacons each arranged at a known location and configured to detect the presence of one or more resources within a range of the beacon.

In embodiments, the positioning system can deliver requests for the identifier attributes of resources having a fixed resource type to the fixed location data source and requests for the location attributes of resources having a movable resource type to the movable location data source.

In embodiments, a map display device can be configured to render a view of one of the one or more active maps based on the stored plurality of renderable structures of the active map. The map generation device can be further configured to determine a current location of a user and define the current area for each of the one or more active maps based on the current location of the user. The map generation device can be further configured to retrieve the map definition for each of the one or more active maps based on a configuration associated with a user.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures.

FIG. 1 is a block diagram depicting components of a supply chain management system, according to an embodiment.

FIG. 2 is a block diagram depicting components of a client interface, according to an embodiment.

FIG. 3A is a screenshot depicting an example user interface screen, according to an embodiment.

FIG. 3B is a screenshot depicting an example user interface screen, according to an embodiment.

FIG. 3C is a screenshot depicting an example user interface screen, according to an embodiment.

FIG. 3D is a screenshot depicting an example user interface screen, according to an embodiment.

FIG. 4 is a block diagram depicting components of an application server, according to an embodiment.

FIG. 5A is a block diagram depicting a schematic view of a configuration definition and a user interface element, according to an embodiment.

FIG. 5B is a block diagram depicting a schematic view of an action definition, according to an embodiment.

FIG. 5C is a block diagram depicting a schematic view of a map definition, according to an embodiment.

FIG. 6 is a code listing depicting an example configuration definition, according to an embodiment.

FIG. 7A is a block diagram depicting components of a query management engine, according to an embodiment.

FIG. 7B is a block diagram depicting components of a positioning system, according to an embodiment.

FIG. 8 is a block diagram depicting an architecture of a supply chain management system, according to an embodiment.

FIG. 9 is a flowchart depicting a method for requesting a configuration, according to an embodiment.

FIG. 10 is a flowchart depicting a method for identifying a configuration, according to an embodiment.

FIG. 11 is a flowchart depicting a method for rendering a dashboard, according to an embodiment.

FIG. 12 is a flowchart depicting a method for managing data requests, according to an embodiment.

FIG. 13 is a flowchart depicting a method for managing queries, according to an embodiment.

FIG. 14 is a flowchart depicting a method for locating resources, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

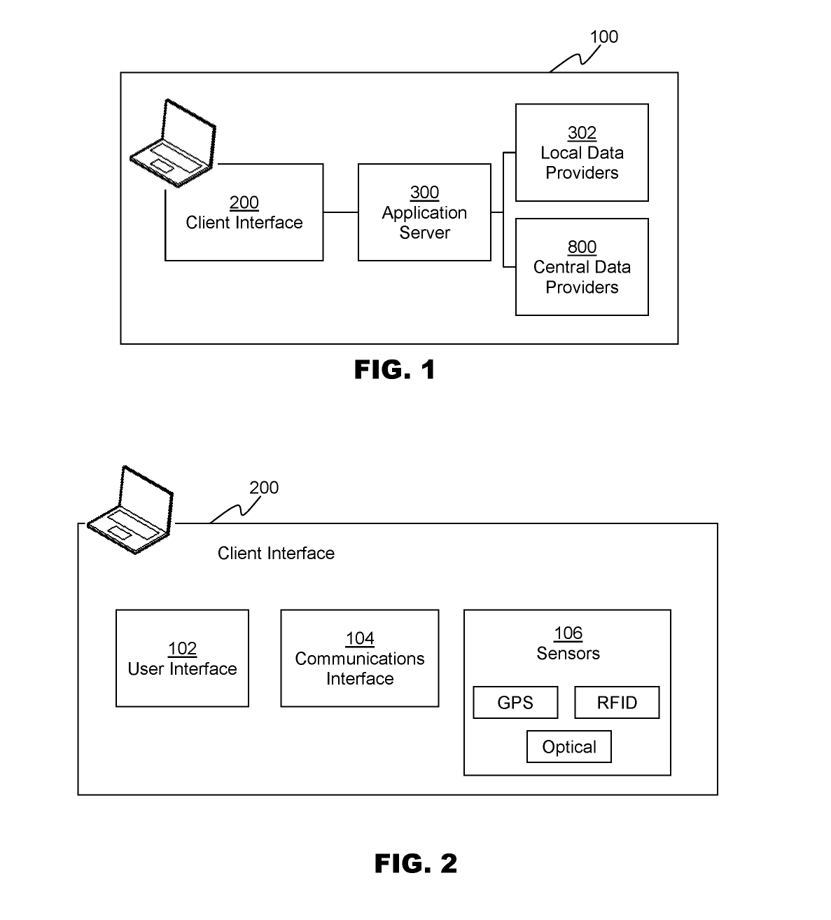

Embodiments relate to a supply chain management system that can provide dynamically populated user interface elements to one or more client interfaces 200. FIG. 1 is a block diagram depicting a schematic view of an architecture of a supply chain management system 100 according to an embodiment. Application servers 300 can receive data and action requests from a plurality of client interfaces 200 and manage the retrieval or modification of data. In embodiments, multiple application servers 300 can be provided at each of a plurality of sites such as distribution centers or warehouses. Each application server 300 can interact one or more client interfaces 200, with local data providers 302 and/or central data providers 800.

FIG. 2 is a block diagram depicting a schematic view of a client interface, 200. Client interfaces 200 can comprise mobile applications, web-based applications, or any other executable application framework. Client interfaces 200 can reside on, or be accessed by any computing devices capable of communicating with application server 300, receiving user input, and presenting output to the user. In embodiments, each client interface 200 can reside on a smartphone, a tablet computer, or a mobile retail computer device such as an MC40 or TC70 as manufactured by Motorola.

Client interfaces 200 can comprise user interface 102 enabling a user to interact with various user interface elements based on a predetermined configuration. User interface 102 can comprise a display generator. The display generator can reside directly on a mobile or other remote client device, or can reside on application server 300. The display generator can further comprise a map generator.

Each client interface 200 can further comprise one or more data communication interfaces 104 enabling client interface 200 to communicate with application server 300 or other components of system 100 as required. Data communication interfaces 104 can include wired connections such as Ethernet connections, Universal Serial Bus (USB), and the like; wireless connections such as WiFi, Bluetooth, Zwave, ZigBee, I2C, and the like; and/or other communication interfaces or protocols enabling data communication between client interface 200 and other components of system 100.

In embodiments, each client interface 200 can comprise one or more sensors 106 enabling the client interface 200 to actively or passively detect data regarding the surrounding environment. Data can be requested from the sensors 106 on a regular or random basis regardless of the task being performed. Sensors 106 can comprise optical sensors (such as cameras), temperature sensors, pressure sensors, position sensors, infrared sensors, microphones, moisture sensors, and/or some other sensor capable of sensing and returning data to client interface 200.

In embodiments, sensors 106 can comprise components for reading and/or decoding tag information on physical assets. Such components can include barcode scanners, cameras, radio frequency identification (RFID) transponders, and the like. This can improve efficiency and accuracy as the user does not have to manually enter an asset identifier.

In embodiments, sensors 106 can comprise a location monitor to track the location of the client interface 200. This monitoring can assist in determining the user's location in order to present relevant location specific user interface elements. The location can be determined in real time (or near-real time) by locating the user, or the client interface 200 associated with the user. Location sensors can comprise global positioning system (GPS) receivers. Location sensors can operate via geolocation, Wi-Fi or other wireless triangulation, dead reckoning, or other locating techniques as are known in the art.

Each client interface 200 can be independent of other client interface 200, such that multiple users can separately access and interact with system 100. Each client interface 200 can comprise one or more output interfaces (such as a screen, audio output, or haptic output), and one or more input interfaces (such as a touch screen, keyboard, mouse, or microphone).

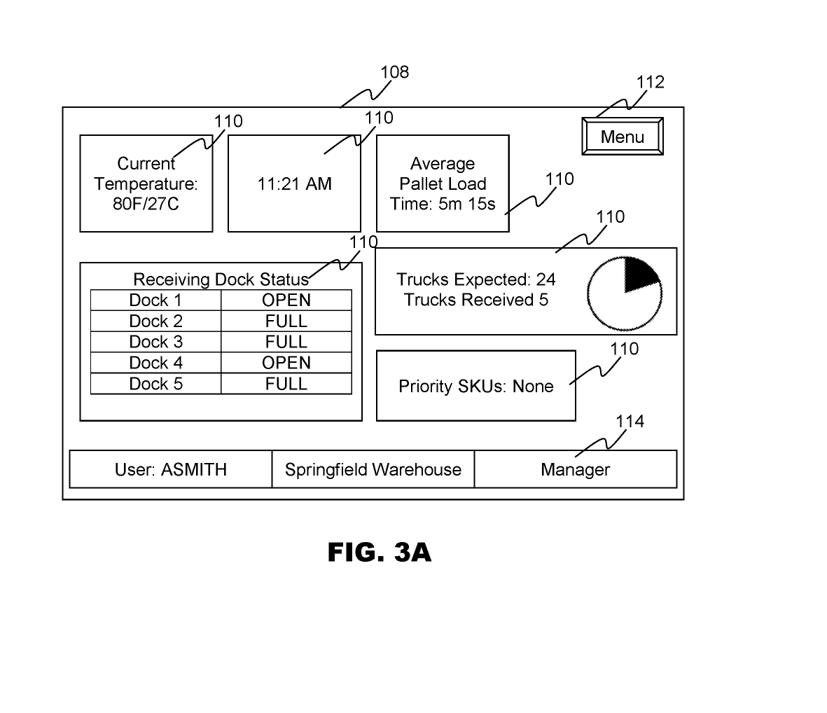

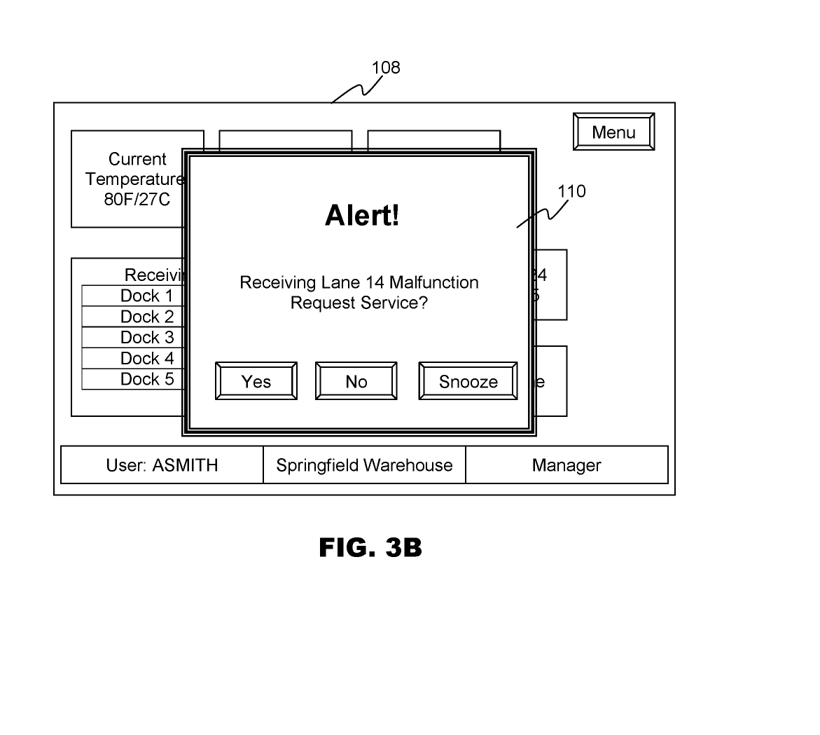

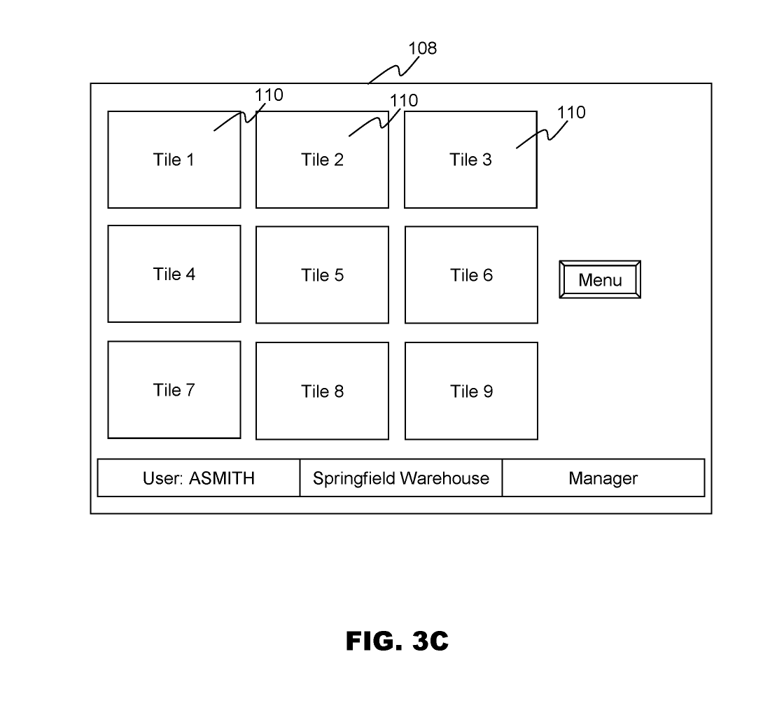

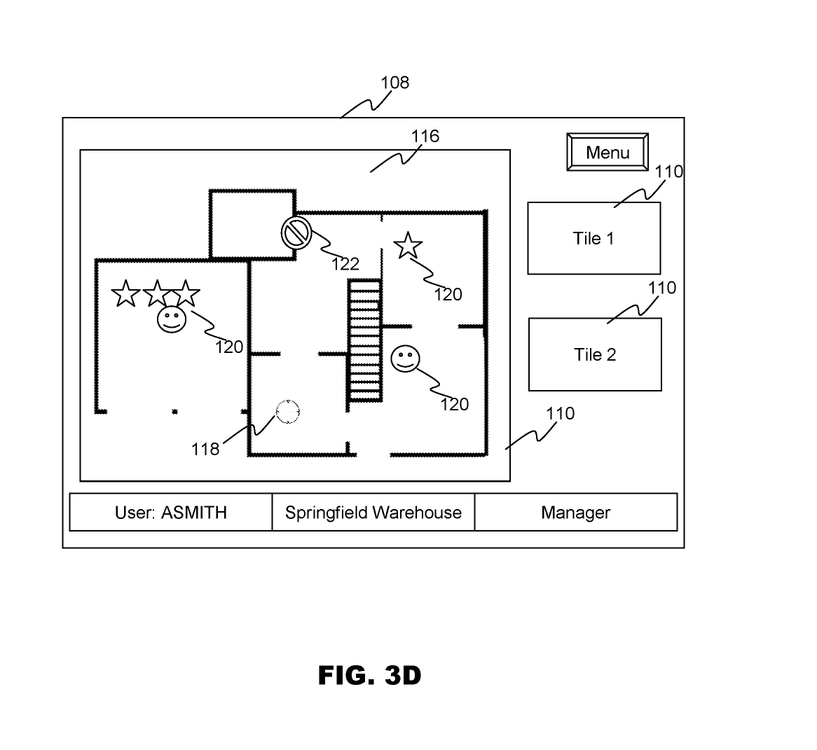

Turning now to FIGS. 3A-3C, client interface 200 can present dashboard screens 108 including a variety of display units 110. Each display unit 110 can be rendered based on a user interface element 500 defined by a configuration definition 404 (as discussed below). Dashboard screens 108 can further include a menu 112, providing configuration options, and a user information bar 114, providing information regarding the current user, including user name, location, and role. In embodiments, display units 110 can be clickable or selectable by the user and additional detail can be displayed. As depicted in FIG. 3B, display units 110 can include alerts or other forms of notifications that can be displayed as pop-ups to notify the user, though other methods of providing notifications—such as audio alerts, haptic feedback, or other visual display styles—can be used in embodiments. Client interface 200 can receive configuration definitions 404 and other data to populate dashboard screens 108 from application server 300. FIG. 3C depicts an alternate example dashboard screen 108, in which each display unit 110 comprises an equally sized tile.

Dashboard screens 108 can comprise graphical user interface (GUI) screens within personal computer (PC) or mobile apps, web pages for access via web browsers, or other screen display techniques known in the art.

In embodiments, one or more display units 110 can comprise map view 116, as depicted in FIG. 3D. Map views 116 can present a floor plan or some other two- or three-dimensional view of a facility or area. Map view 116 can present a cross-hair marker 118 indicating the current position of the user, if the user's position is within the extent, or area, of the map. In embodiments, the extent of the map can adjust based on the current position of the user. Map view 116 can further depict one or more markers 120 depicting resources such as assets or associates in their relative locations in the area. Status markers 122 can be altered to indicate the status of a resource, such as an open or closed door. Status can also be indicated by other map components, such as a heat maps.

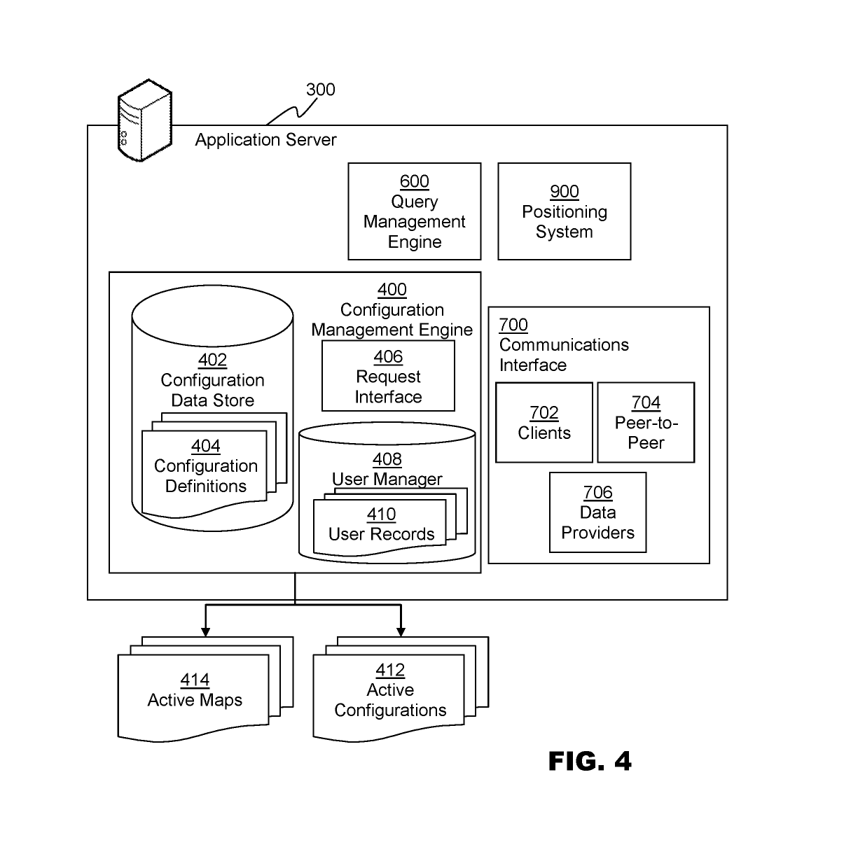

FIG. 4 is a block diagram depicting a schematic view of components of an application server 300. Application server 300 can comprise a configuration management engine 400. Configuration management engine 400 can comprise a configuration data store 402 which can store one or more configuration definitions 404. Request interface 406 can receive requests for configuration definitions 404 based on a user identification, user role, user location, or other criteria.

User manager 408 can comprise a data store including one or more user records 410. User record 410 can include user information including user identification and authentication information (such as user names, passwords and/or password hashes), and user tracking data, such an indication of whether a user is currently logged in, which device they are using, and a current location of the user. In embodiments, user manager 408 can store user records 410 locally. In alternative embodiments, all or portions of user records 410 can be retrieved and/or verified by one or more central data providers 800. User records 410 can comprise more, fewer, or alternate data elements in embodiments. User records 410 and configuration data store 402 can enable configuration management engine 400 to provide an active configuration set 412 including data elements linking to or including the configuration definition 404 for each logged in user.

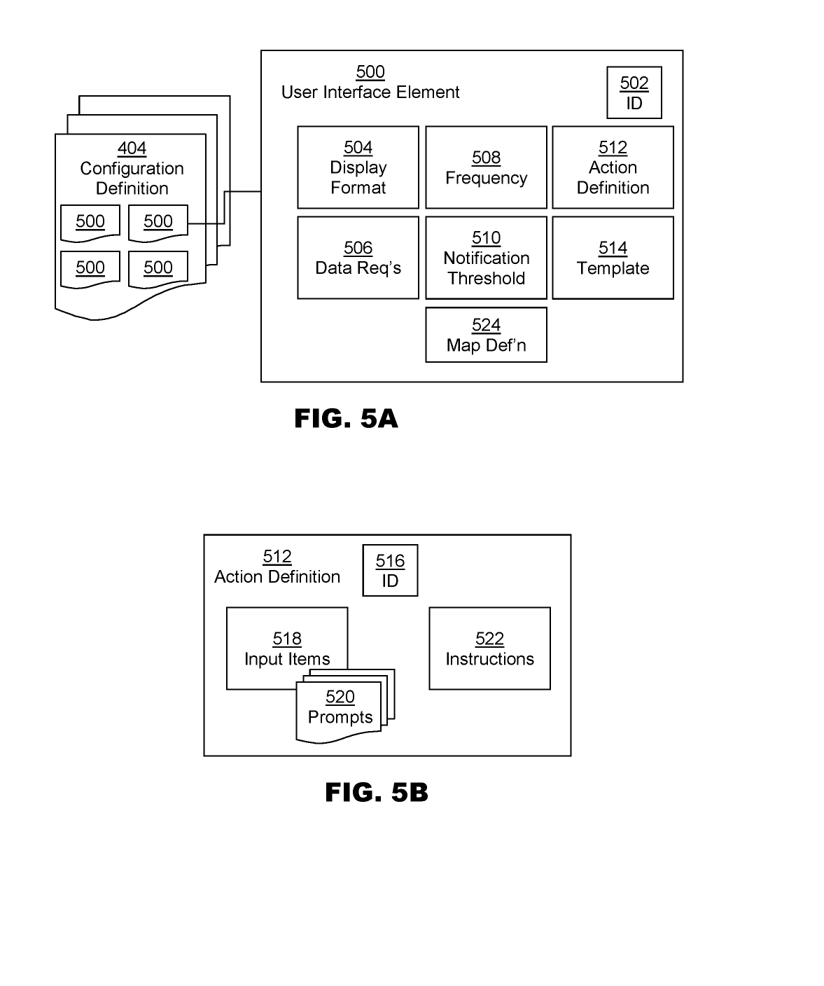

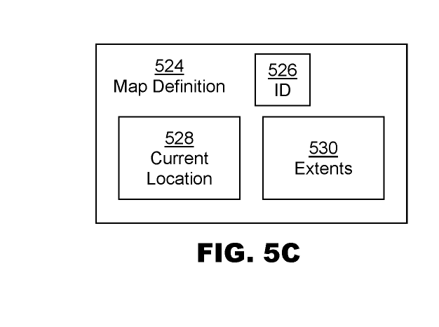

FIG. 5A is a schematic view depicting data elements of a configuration definition 404. Configuration definition 404 can store data defining the display of a dashboard 108 that can be rendered on client interface 200. Configuration definition 404 can contain one or more user interface elements 500, which can define tiles, windows, widgets, dialogs, notifications, or other elements to be rendered as display units 110. Each user interface element 500 can comprise an identifier 502, such as name, a display format 504, one or more data requirements 506, and a refresh frequency 508. In embodiments, user interface elements 500 can comprise notifications, including notification thresholds 510, such that the user interface element 500 will only be displayed if the notification threshold 510 is met. In embodiments, user interface elements can comprise widgets, which can enable the user to enter data and cause system 100 to perform a selected action. Widgets can comprise action definitions 512. In embodiments, widgets can also comprise notification thresholds 510, such that the user is given the option to take an action if the notification threshold 510 is met.

FIG. 5B is a schematic view depicting data elements of an action definition 512, according to an embodiment. Action definition 512 can comprise an action ID 516. Action definition 512 can further comprise one or more input items 518 and associated prompts 520. Input items 518 can define user inputs to be provided with instruction 522 when an action is requested. Each prompts 520 can define controls, text, or other output to be provided to the user to ask for each input item 518.

In embodiments, prompts 520 can present multiple options to the user (for example, the “Yes”, “No”, and “Snooze” buttons depicted in FIG. 3B). In embodiments, prompts 520 can be at least in part populated based on data received from application server 300. For example, the user can be asked to specify a specific dock from the list of receiving docks depicted in FIG. 3A.

Instructions 522 can comprise scripts or other sets of commands or instructions that are executable by application server 300, by local data providers 302, central data providers 800, or other external components or systems. Instructions 522 can comprise code, such as computer programming code in Java, C, Ruby, Python, or any other programming language. Instructions 522 can comprise sets of statements in database manipulation and/or control languages such as Structured Query Language (SQL), Hive Query Language, and the like. Instructions 522 can further comprise combinations of any of the above.

Examples of actions that can be initiated in embodiments include: generating maintenance requests, reassigning staff or other resources, sending messages, and/or updating shipment, task, or job statuses, though other actions can be performed.

In embodiments, user interface elements 500 can optionally include, or provide information linking to, an element template 514. Element templates 514 can provide instructions enabling the rendering of specific types of units 110. For example, a pie chart element template can comprise logic, code, or other information defining the display of a pie chart, and receive parameters defining the data elements to be used to render the chart, as depicted in FIG. 3A. Element templates 514 can enable the display of complex data without coding or excessive configuration steps.

In embodiments, user interface elements 500 can optionally include can include, or provide information linking to, a map definition 524. FIG. 5C is a block diagram depicting a map definition 524. Each map definition 524 can comprise an identifier 526. Each map definition 524 can further comprise a current location 528 and extents 530. Current location 528 can be a fixed location, or can vary based on the user's current location. Extents 530 can be updated based on the user's location or other configuration options. For example, a user can create a map definition 524 of a particular facility with fixed extents 530.

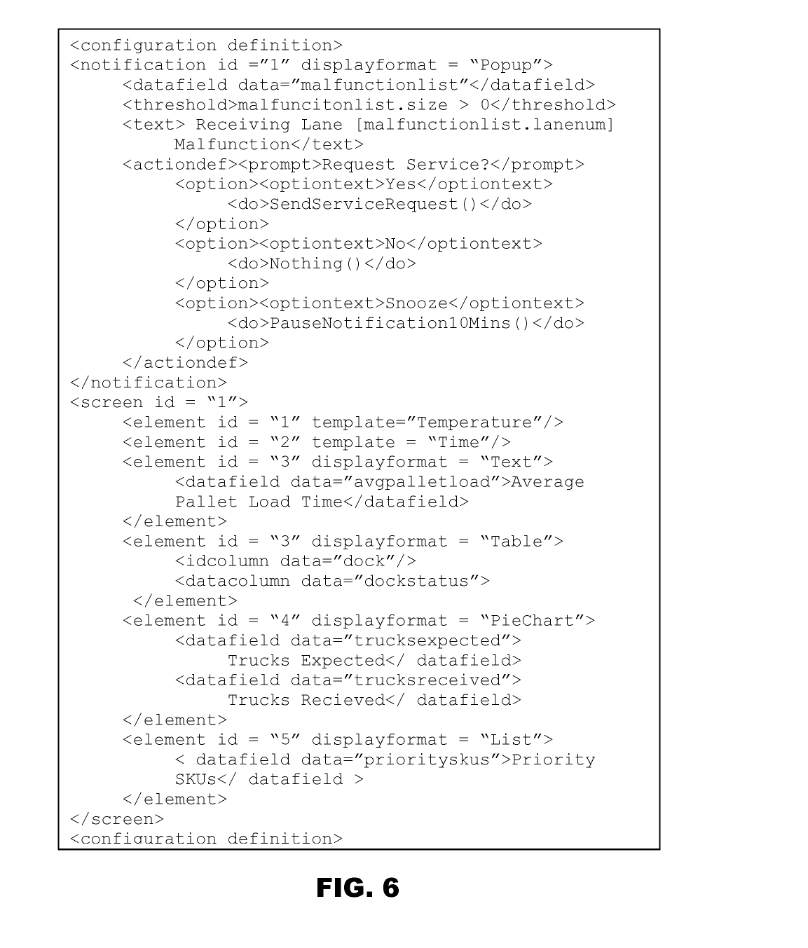

In embodiments, user interface elements 500 and/or configuration definitions 404 can comprise one or more data files in a markup language such as Hyper Text Markup Language (HTML), or eXensible Market Language (XML). In embodiments, an XML-based user interface markup language such as User Interface Description Language (UIDL), XML User Interface Language (XUL), or eXtensible Application Markup Language XAML can be used. FIG. 6 is a code listing depicting an example configuration definition 404 data file defining the example dashboard of FIGS. 3A and 3B in a pseudo-markup language.

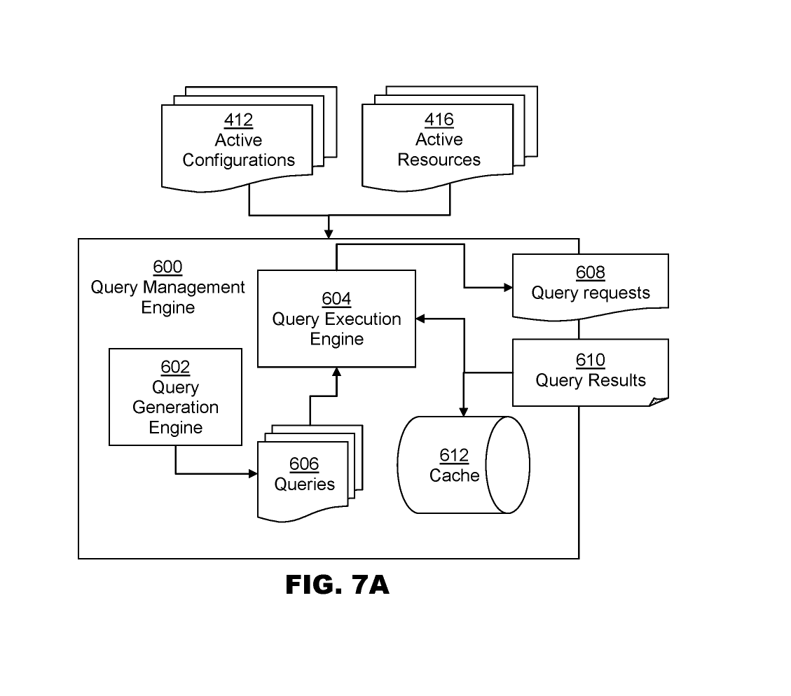

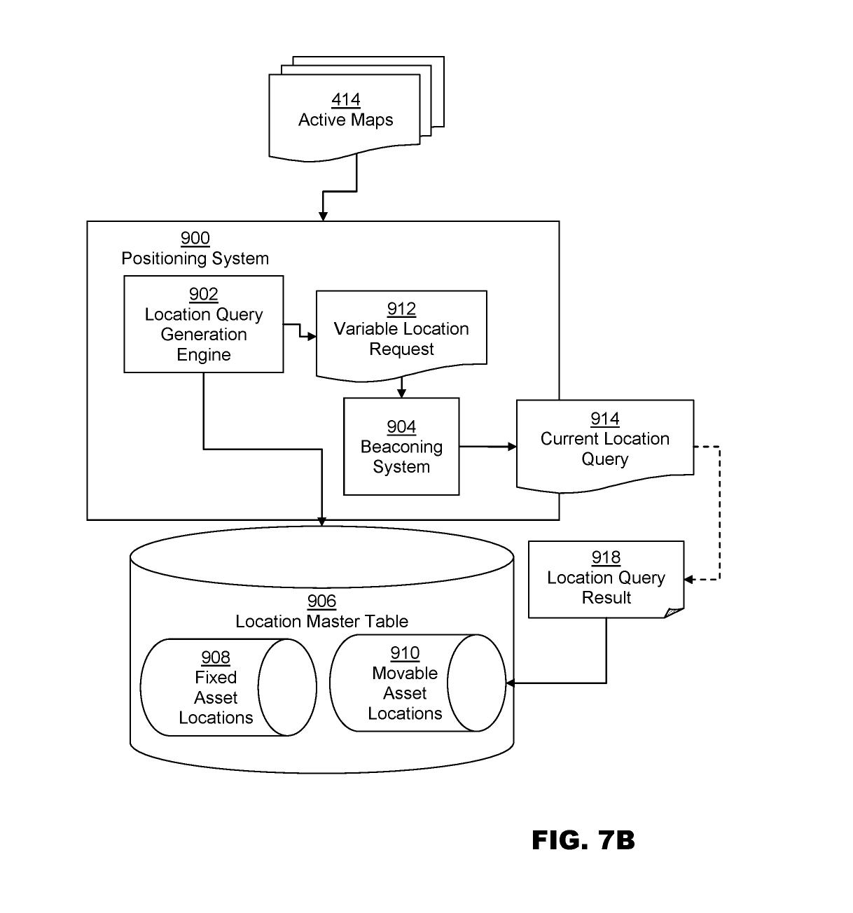

FIG. 7A is a block diagram depicting components of a first resource data provider, query management engine 600, according to an embodiment. Query management engine can comprise query generation engine 602, and query execution engine 604.

Query generation engine 602 can be in data communication with configuration manager 400 to receive active configurations 412 and/or active resources 416. Query generation engine 602 can process active configurations 412 and active resources 416 to determine a set of data requirements and resource attributes currently required. Query generation engine 602 can generate one or more queries 606. Each query 606 can be assigned an interval according to the frequencies of each user interface element 500.

Query execution engine 604 can be in data communication with local data providers 302 and central data providers 800 to send query requests 608, which can comprise queries 606 and/or requests for indexes to optimize data retrieval time for the current queries. Query execution engine 604 can receive query results 610, including data items requested by client interfaces 200. In embodiments, all or portions of query results 610 can be stored in cache 612 for faster retrieval.

FIG. 7B is a block diagram depicting components of a second resource data provider, positioning system 900, according to an embodiment. Positioning system 900 can comprise location query generation engine 902 and beaconing system 904. Location query generation engine 902 and beaconing system 904 can be in data communication with location master table 906, which can reside in positioning system 900 or one or more separate data stores.

Location master table 906 can comprise fixed asset data store 908 and movable asset data store 910. Fixed asset data store 908 can comprise a static (or generally rarely changing) data set listing the locations of fixed assets known to system 100. Movable asset data store 910 can be updated on an ongoing basis.

Location query generation engine 902 can receive location data from location master table 906. Location query generation engine 902 can generate movable location requests 912 as needed, which can be processed by beaconing system 904 to generate one or more current location queries 914. Beaconing system 914 can be in data communication with local data providers 302 and central data providers 800 to send current location queries 914 and receive location query results 918. Location query results 918 can be stored in movable asset data store 910 as location records.

Returning now to FIG. 4, communications interface 700 provides data communication with various components both of system 100. Client interface 702 can manage connections to the various client interfaces 200 that are connected to application server 300. Peer-to-peer interface 704 can manage connections between the various application servers 300. Data provider interface 706 can manage connections to local data providers 302, and central data providers 800. Communication interface 700 can comprise wired connections such as Ethernet connections, Universal Serial Bus (USB), and the like; wireless connections such as WiFi, Bluetooth, Zwave, ZigBee, I2C, and the like; and/or other communication interfaces or protocols enabling data communication.

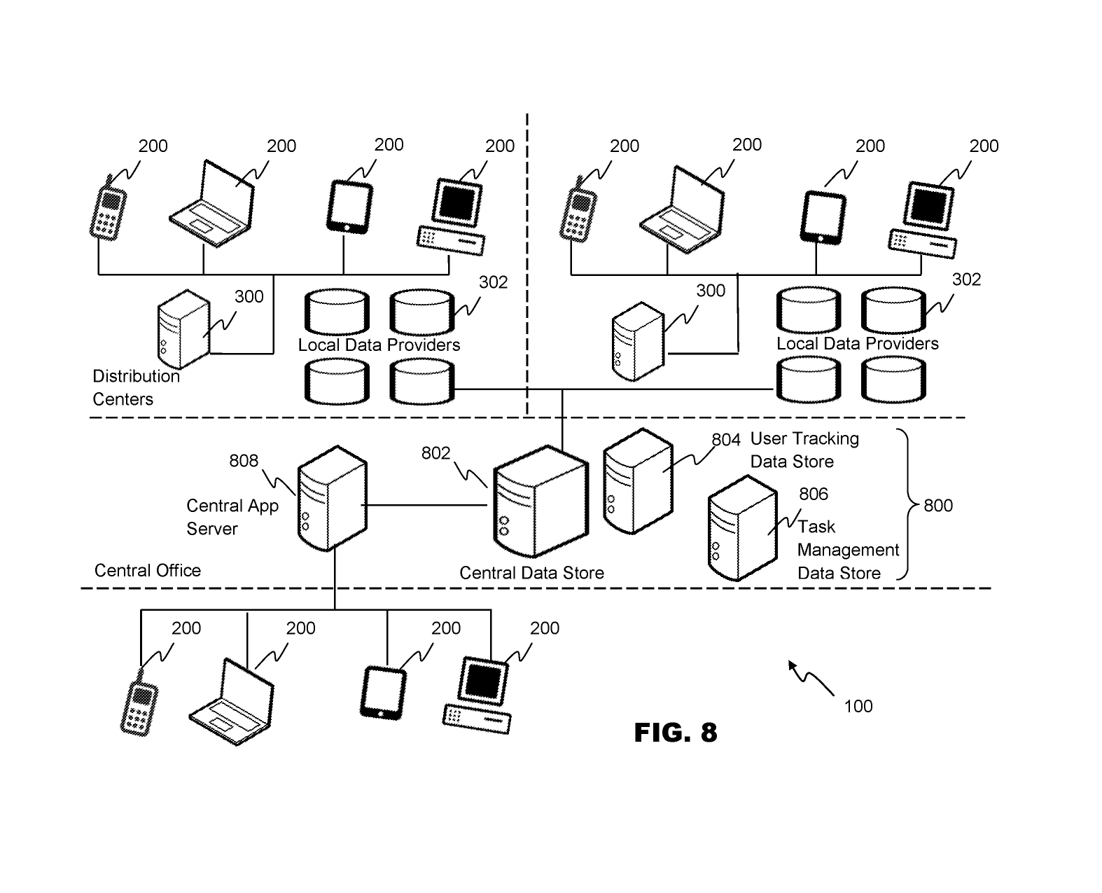

FIG. 8 is a block diagram depicting a schematic view of the architecture of an embodiment of system 100. The depicted architecture assumes a plurality of distribution centers, each having a separate application server 300 and set of local data providers 302. The various distribution centers can be in data communication with other distribution centers and and/or central data providers 800 located and one or more central offices.

Central data providers 800 can comprise a central data store 802. Central data store 802 can comprise one or more computing systems configured to provide data storage, backup, archival, and/or retrieval services. Central data providers 800 can be located at a single location, or have a distributed architecture. Central data providers 800 can comprise database systems, or other services that can be programmatically accessed via one or more API (application programming interfaces) or other communication methods. Data provider interfaces 706 can enable communication with each of a heterogeneous mix of central data providers 800.

User tracking data store 804 can be a user activity tracker, and comprise a human resources database or system, or any other service or system capable of storing and providing data regarding the last known or expected location or site of one or more users. In embodiments, user tracking data store 804 can store GPS or other geolocated coordinates provided by client interface 200. In embodiments, one or more beacons (not shown) can provide the identity of client interfaces 200 that are detected within the range of the beacon. The location of the user can therefore be inferred to be close to the known location of the beacon.

In embodiments, task management data store 806 can be provided. Task management data store can comprise a database or system configured to monitor task assignment and performance. For example, task management data store 806 can receive data indicating that a particular user has completed a task at a known location, for example unloading a pallet of goods. Task management data store 806 can therefore provide data enabling user tracking data store 804, or application servers 300 to infer the location of the user.

In embodiments, a central application server 808 can be provided. Central application server 808 can comprise the same or similar components as application servers 300, however central application server 808 can receive data directly from central data store 802, or other central data providers 800. Users at retail sites, or other locations remote from distribution centers can use client interfaces 200 to interface with central application server 808.

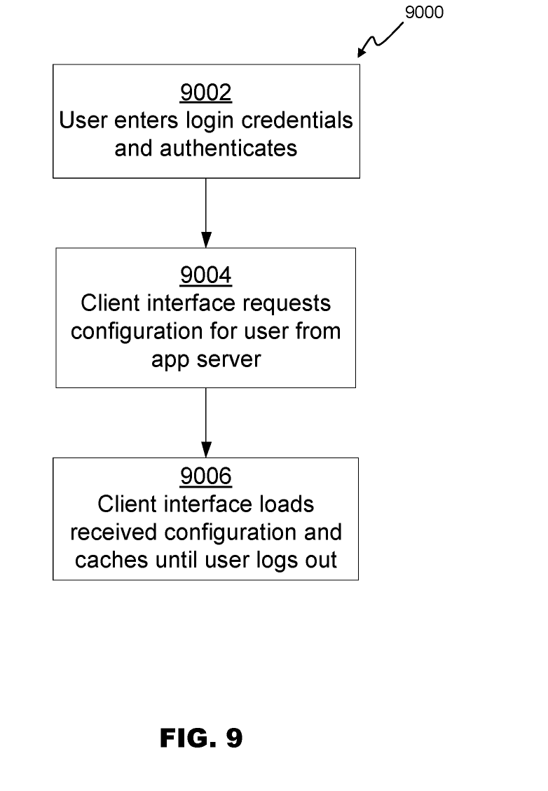

In operation, client interface 200 can present dashboard 108 based on a configuration definition 404 selected for a user's identity, role, and/or location. FIG. 9 is a flowchart depicting a configuration request method 9000, according to an embodiment. At 9002, client interface 200 can receive the login credentials for a user. Login credentials can include names, user names, passwords, PINs, optical or other scan input, fingerprint input, or any other identifying and/or authenticating information. Client interface 200 can authenticate the user locally, or can request authentication from application server 300, or central data providers 800. At 9004, client interface 200 can request a configuration for the user from application server 300. At 9006, client interface 200 can render dashboard 108 according to a received configuration definition 404.

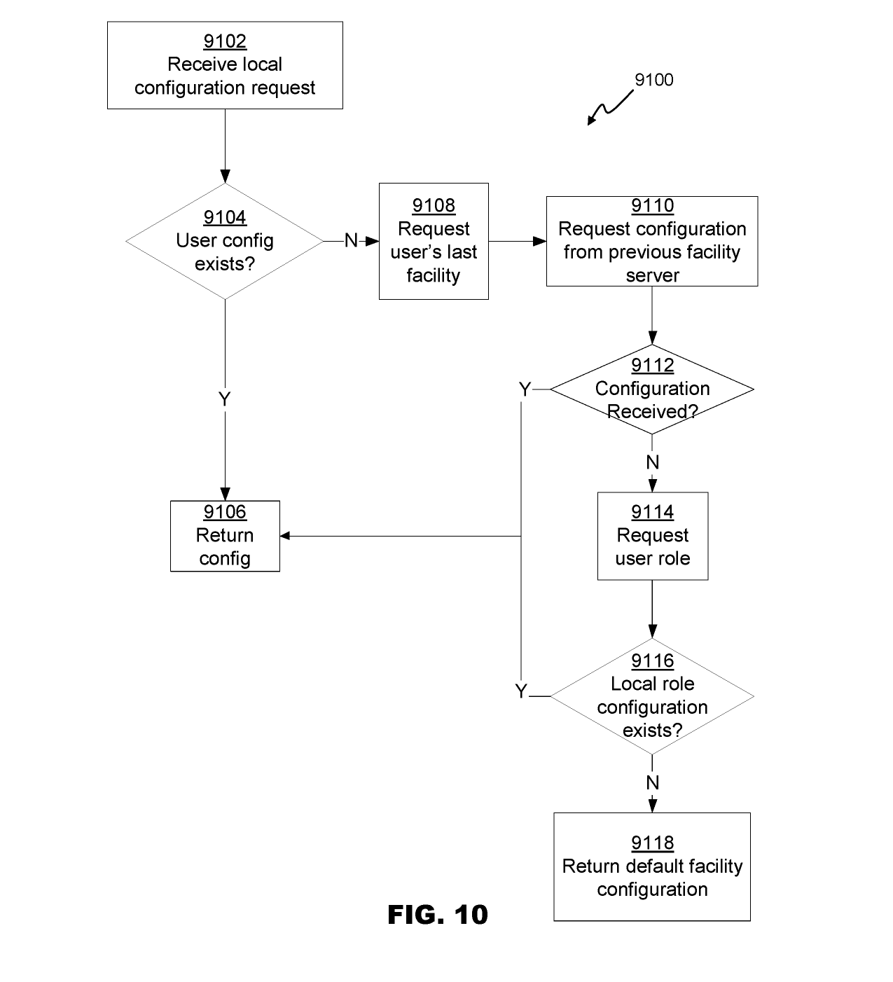

Users of system 100 create one or more custom configuration definitions 404. FIG. 10 is a flowchart depicting a configuration selection method 9100 according to an embodiment. At 9102, a configuration request can be received. At 9104, if a local configuration definition 404 exists, it can be returned at 9106. If no local configuration definition 404 exists, the user's last facility can be request 9108. The last known location of the user can be requested from central data store 802, user tracking data store 804, task management data store 806, or a combination thereof. At 9110, a peer-to-peer request for a configuration definition for the user can be sent to the application server 300 of the user's previous facility. At 9112, if a configuration was received, it can be returned at 9106.

If, at 9112, no configuration is received from a previous facility, the user's role can be requested at 9114. The user's role can be known to application server 300, or provided by central data store 802 or user tracking data store 804. At 9116, if a default configuration for the role exists, it can be returned at 9106. If no configuration for the role exists, at 9118, the default configuration for the application server 300 can be returned.

Method 9100 enables application server 300 to attempt to find a user-specific configuration, and if unsuccessful, a role and/or location-specific configuration definition 404 for return to client interface 200. Other configuration selection methods can be used, however. For example, each application server 300 can return a single facility-specific configuration in embodiments. In other embodiments, role or user specific configurations can be stored exclusively by one of central data providers 800.

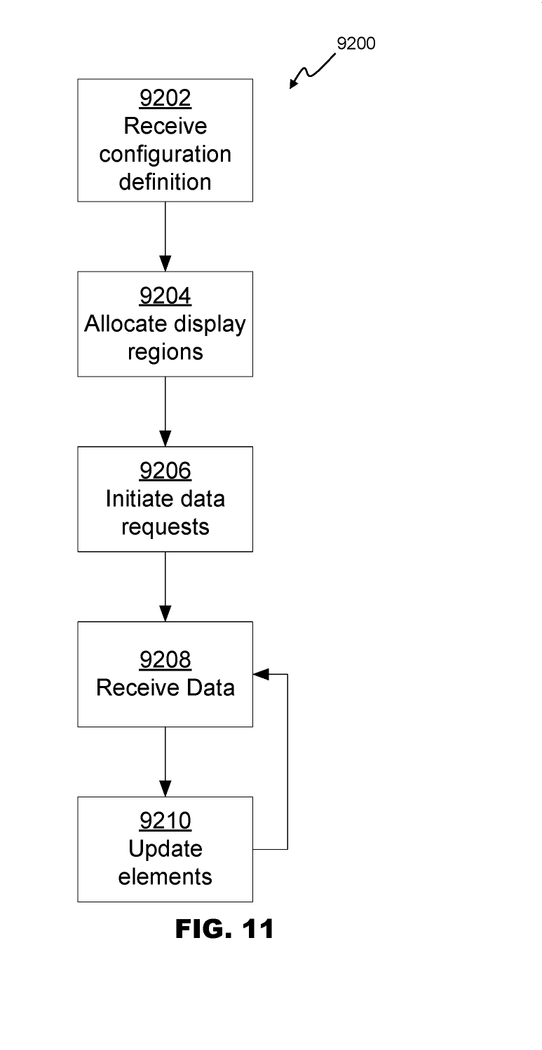

FIG. 11 is a flowchart depicting a method 9200 for rendering a user dashboard 108. At 9202, the configuration definition 404 can be received. At 9204, display regions can be allocated to each user interface element 500 of configuration definition 404. Multiple methods can be used to allocate display regions by embodiments. For example, each display unit 110 can comprise a tile with a standard size, as depicted in FIG. 3C. User interface elements 500 can be rendered for each tile within the space provided be allocated the same amount of space. As another example, display units 110 can be sized based on the rendered size of each user interface element 500, or the relative size of each user interface element 500 can be defined in configuration definition 404. FIGS. 3A and 3B depict examples of display units 110 with varying sizes. Other methods, or combinations of methods for allocating display regions can be used by embodiments. Dashboards 108 can be rendered responsively, such that display units 110 are resized according to the size or capabilities of the client device.

Returning now to FIG. 11, at 9206 data requirements 506 can be communicated to application server 300. Requests for data requirements 506 can include information identifying the user, the client interface 200, and the active configuration definition 404. In alternative embodiments, the configuration definition 404 that is active on client interface 200 can be known to application server 300 based on a prior configuration request. At 9208, data results can be received from application server 300, and at 9210 the various elements of display units 110 can be updated based on the received data. Data results can include error codes which can be displayed as part of display units 110, or logged by client interface 200. Control can loop between receiving data at 9208 and updating the display at 9210 until the user logs out.

Data results 610 can be returned in multiple formats such as JavaScript Object Notation (JSON), or other data interchange formats. In embodiments, the data received by client interface 200 can be an HTML or other markup language file fully describing the rendered display. In other embodiments, the data receive by client interface 200 can comprise key-value pairs including only the requested data items, to be rendered by client interface 200.

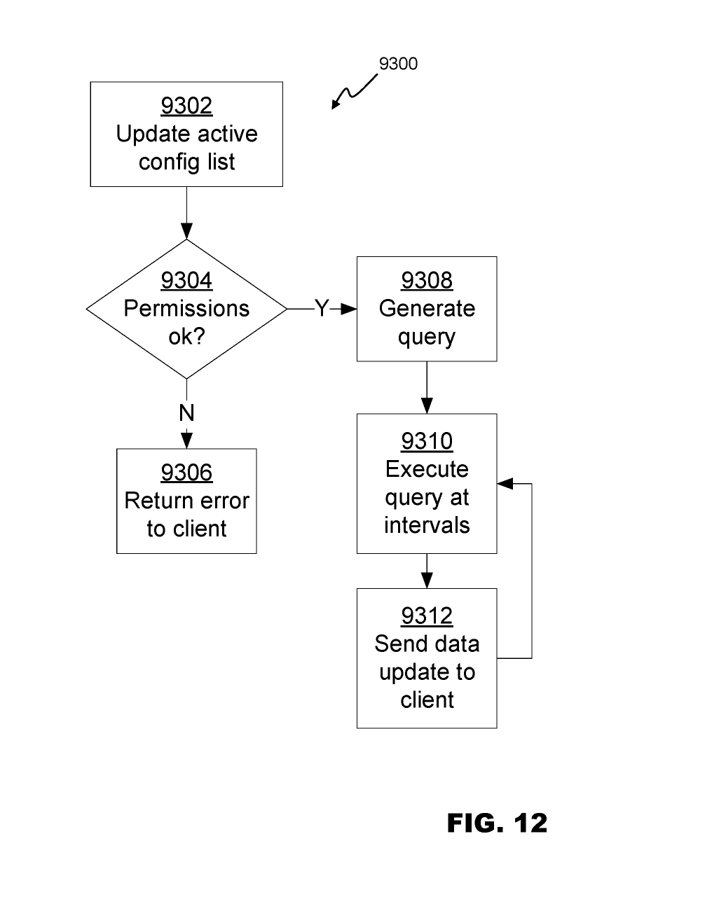

FIG. 12 is a flowchart depicting a method 9300 for management of data requests by components of application server 300, such as query management engine 600. At 9302, a list of active users can be updated to store user and/or configuration information for each client interface 200. In one embodiment, configuration definitions 404 can be stored with the active user list. In other embodiments, configuration definitions 404 can be determined based on the most recent configuration definition 404 returned for the user of a client device.

At 9304, the data requirements 506 for each user interface element 500 of each configuration definition 404 associated with an active configuration 412 can be determined, and an error can be returned to the appropriate client device at 9306 if the user does not have the necessary access privileges to view the data. If no permissions errors arise, a query 606 can be generated 9308 to retrieve the data requirements 506 from the appropriate data sources. At 9310, each query can be executed at the appropriate intervals. Queries 606 can be executed against one or more local data providers 302, or central data providers 800 as appropriate. Query results 610 can be returned to the client interfaces 200 at 9312.

In embodiments, query management engine can additional store some or all of query results 610 in cache 612. If multiple configuration definitions 404 require the same data element at different intervals, the results of one query can be cached for response to a later query. Caching can be based on one or more data staleness and/or freshness parameters associated with each data request, enabling query execution engine 604 to determine whether the cached data needs to be updated before being returned.

Control can return to 9310 to execute each query 606 as needed. Method 9300 can run continuously, with the set of active configurations 412 updated at particular intervals. The set of active configurations 412 can also be updated intermittently as client interfaces 200 communicate that a user has logged on or logged off. Because queries are only executed based on the set of active configuration 412, only those queries that are necessary to provide information to active users are run, which can save bandwidth and processing resources. In addition, caching of data can further reduce unnecessary data requests.

Client interface 200 can enable the user to initiate actions. Actions can be initiated by user input on a display unit 110. As depicted in FIG. 3B, the user can receive action initiation prompts as part of a notification. In addition, action initiation prompts can be displayed on one or more screens of dashboards 108. An action request can comprise an action definition 512, including any user-specific input provided.

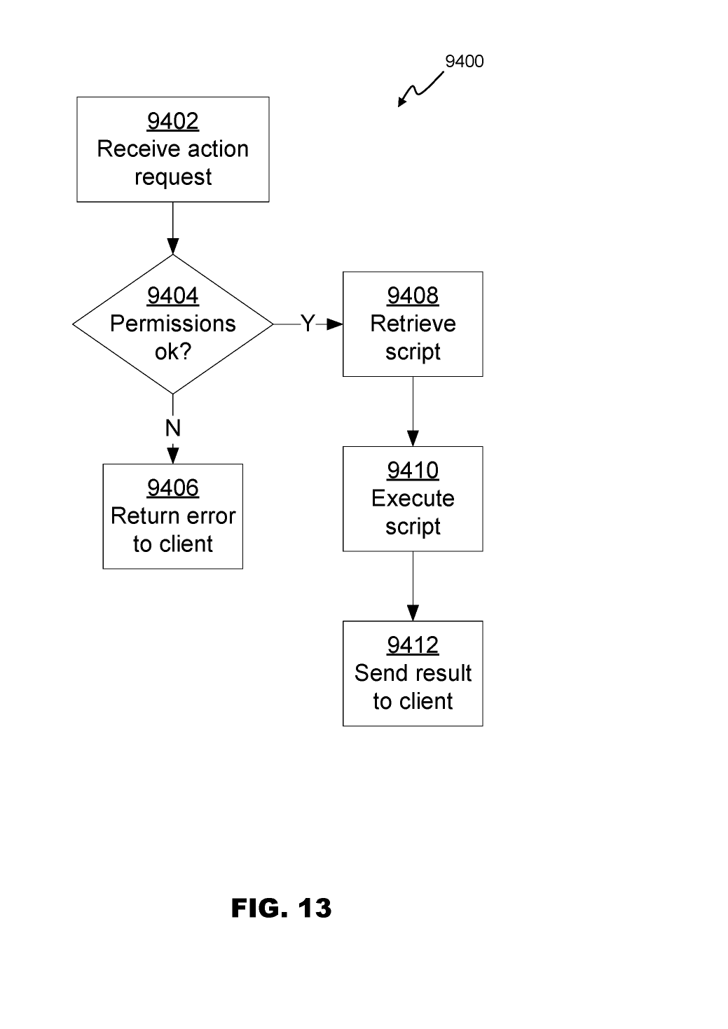

FIG. 13 is a flowchart depicting a method 9400 for management of action requests by components of application server 300, such as query management engine 600. At 9402, an action request including an action definition 512 can be received. The action request can optionally include user-provided input. At 9404, an error can be returned to the appropriate client interface 200 at 9406 if the user does not have the necessary access privileges to perform the action. If no permissions errors arise, at 9408, the instructions 522 to be executed can be retrieved based on a received action definition 512. In embodiments, action definition 512 can comprise the instructions 522, or a link to a script including the instructions 522 to be executed. For example, in the code listing of FIG. 3B, each option includes an identifier of a script (for example, SendServiceRequest) to be executed, but not the code for the script itself. Application server 300 can use the identifier to retrieve the script from internal and/or external data stores. If the application server 300 cannot identify the script, an error can be thrown. At 9410, the instructions 522 can be executed by application server 300. During execution, application server 300 can make updates or service calls to the appropriate local data provider(s) 302 and/or central data provider(s) 800 as required by instructions 522. At 9412, a result can be sent to the client, comprising any return value received by the execution of the instructions 522.

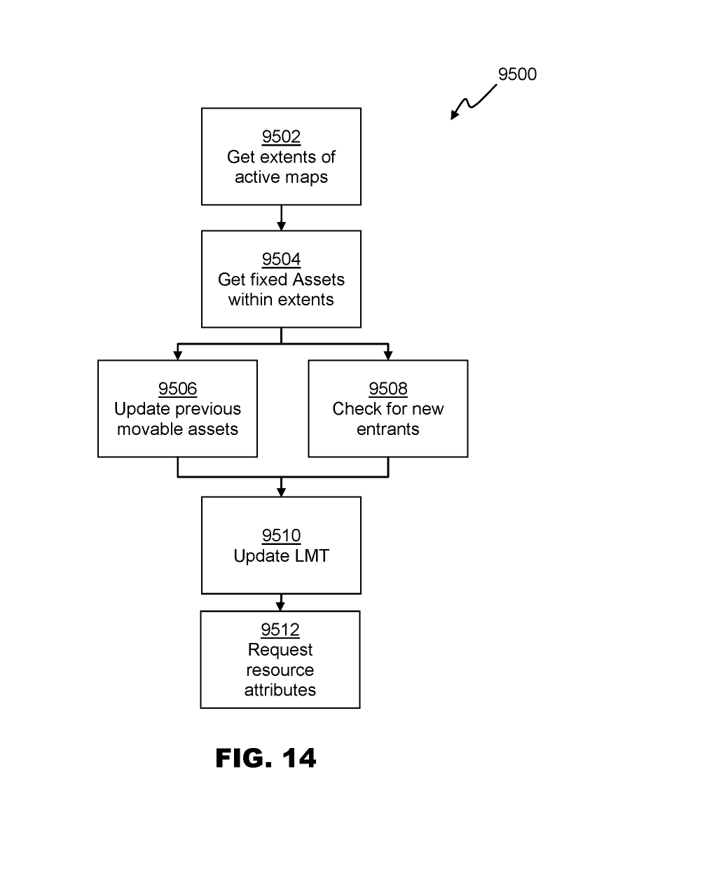

FIG. 14 is a flowchart depicting a method 9500 for determining which resources exist within the extent of one or more active maps 414. At 9502, the set of active maps 414 can be received. At 9504, the fixed location data store can be searched for entities within the extent of each active map. At 9506, the movable location data store can be searched for a list of resources that were previously known to be within the extents of the active maps 414, and their locations can be checked. For example, an HR database or other central data provider 800 can be queried to determine if an identified associate is still scheduled to be working. Similarly, an asset management data store or other central data provider 800 can be queried to determine if an asset is still active.

At 9508, new entrants can be detected. The HR database can be queried to determine the identities of any new associates that are newly scheduled to be working. Similarly, beacons within the extents of active maps 414 can be queried for the identifiers of any nearby assets.

At 9510, the movable location data store can be updated based on the results of 9506 and 9508. At 9512, requests for resource attributes can be submitted to query management engine 600.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

In one embodiment, the system 100 and/or its components or subsystems can include computing devices, microprocessors, modules and other computer or computing devices, which can be any programmable device that accepts digital data as input, is configured to process the input according to instructions or algorithms, and provides results as outputs. In one embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but also to provide the space to store the instructions themselves. In one embodiment, volatile memory can include random access memory (RAM), dynamic random access memory (DRAM), or static random access memory (SRAM), for example. In one embodiment, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In one embodiment, the system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field-10 programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that embodiments may comprise fewer features than illustrated in any individual embodiment described above. The embodiments described herein are not meant to be an exhaustive presentation of the ways in which the various features may be combined. Accordingly, the embodiments are not mutually exclusive combinations of features; rather, embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Moreover, reference in the specification to “one embodiment,” “an embodiment,” or “some embodiments” means that a particular feature, structure, or characteristic, described in connection with the embodiment, is included in at least one embodiment of the teaching. The appearances of the phrase “in one embodiment” in various places in the specification are not necessarily all referring to the same embodiment.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of Section 112, sixth paragraph of 35 U.S.C. are not to be invoked unless the specific terms “means for” or “step for” are recited in a claim.

What is claimed is:

1. A system for automatic augmentation of a map based on resource attributes of one or more resources, each resource being a fixed resource or a movable resource, the system comprising:
one or more resource data providers configured to:
store a plurality of resource attributes including a location attribute and an identifier attribute for each of the one or more resources,
provide the identifier attributes for the resources having a location attribute within a given area, and
provide the plurality of resource attributes for an identified resource based on the identifier attribute of the identified resource;
a map generator configured to retrieve location attributes from a location master table and to store a plurality of renderable structures defining a display of one or more active maps, based on a map definition and a current area of each of the one or more active maps;
a location query generation engine configured to receive the map definition of each of the one or more active maps, generate one or more requests for the identifier attributes of the resources located within the current area of each of the one or more active maps, and generate a request for at least one of the plurality of resource attributes of each identified resource; and
a positioning system configured to deliver each of the one or more requests to the one or more resource data providers and to store the provided attributes in the location master table.

2. The system of claim 1, wherein at least one of the plurality of resource attributes is a resource type attribute.

3. The system of claim 2, wherein the resource type attribute for each of the one or more resources is selected from the group consisting of: a fixed resource type and a movable resource type.

4. The system in of claim 3, wherein the one or more resource data providers comprise:
a fixed location data store configured to provide an identifier attribute for each of the one or more resources having a fixed resource type and a location attribute within an area;
a movable resource locator configured to provide a location attribute for each of the one or more resources having a movable resource type; and
an attribute data store configured to provide the plurality of resource attributes for an identified resource.

5. The system of claim 4, wherein the movable resource locator comprises:
one or more work management systems each work management system arranged at a known location and configured to:
receive a task indication related to a resource, and
communicate information associated with the task indication to a location log database configured to store a location record associated with the task indication, the location record comprising: the known location of the work management system, the identifier attribute of the related resource, and a timestamp;
a current location database configured to request the location record with the most recent timestamp for one or more identified resources;
a beaconing engine configured to provide a location attribute for each of the one or more resources having a movable resource type by:
requesting the most recent location records for the resources having a movable resource type from the current location database;
determining the location attribute for each of the one or more resources based on the most recent location record if the timestamp of the location record is within threshold period; and
determining the location attribute for each of the one or more resources based on a location of one or more beacons each beacon arranged at a known location and configured to detect the presence of one or more resources within a range of the beacon.

6. The system of claim 4, wherein the positioning system delivers requests for the identifier attributes of resources having a fixed resource type to the fixed location data store and requests for the location attributes of resources having a movable resource type to the movable resource locator.

7. The system of claim 1, further comprising a map display device configured to render a view of one of the one or more active maps based on the stored plurality of renderable structures of the active map.

8. The system of claim 1, wherein the map generator is further configured to determine a current location of a user and define the current area for each of the one or more active maps based on the current location of the user.

9. The system of claim 1, wherein the map generator is further configured to retrieve the map definition for each of the one or more active maps based on a configuration associated with a user.

10. A method for automatic augmentation of a map based on resource attributes of one or more fixed or movable resources, the method comprising:
storing a plurality of resource attributes including a location attribute and an identifier attribute for each of the one or more resources;
providing the identifier attributes for the resources having a location attribute within a given area;
providing the plurality of resource attributes for an identified resource based on the identifier attribute of the identified resource;
retrieving location attributes from a location master table;
storing a plurality of renderable structures defining a display of one or more active maps, each of the one or more active maps based on a map definition and a current area of each of the one or more active maps;
generating, based on the map definition of each of the one or more active maps, one or more requests for the identifier attributes of the resources located within the current area of each of the one or more active maps
generating a request for at least one of the plurality of resource attributes for each identified resource; and
delivering each of the one or more requests to one or more resource data providers; and
storing the provided attributes in the location master table.

11. The method of claim 10, wherein at least one of the plurality of resource attributes is a resource type attribute.

12. The method of claim 11, wherein the resource type attribute for a resource is selected from the group consisting of: a fixed resource type and a movable resource type.

13. The method of claim 12 further comprising:
receiving an identifier attribute for each of the one or more resources having fixed resource type and a location attribute within an area from a fixed location data store;
receiving a location attribute for each of the one or more resources having a movable resource type from one or more beacons, each beacon arranged at a known location and configured to detect the presence of one or more resources within a range of the beacon; and
receiving the plurality of resource attributes for an identified resource from an attribute data store.

14. The method of claim 12, further comprising:
receiving a task indication related to a resource at a station at a known location;
storing the known location, information identifying the resource, and a current timestamp in a location log;
receiving a most recent known location and most recent timestamp for each of the one or more resources having a movable resource type;
determining the location attribute for each of the one or more resources based on the most recent known location if the most recent timestamp is within threshold period; and
determining the location attribute for each of the one or more resources based on a location of one or more beacons, each beacon configured to detect the presence of one or more resources within a range of the beacon.

15. The method of claim 11, further comprising rendering a view of one of the one or more active maps based on the stored plurality of renderable structures of the active map.

16. The method of claim 11, further comprising determining a current location of a user and to defining the current area for each of the one or more active maps based on the current location of the user.

17. The method of claim 11, further comprising retrieving the map definition for each of the one or more active maps based on a configuration associated with a user.
